(19) United States
(12) Patent Application Publication
(10) Pub. No.: US 2026/0145110 A1
(43) Pub. Date: May 28, 2026

(54) AIR PURIFICATION SYSTEM

(71) Applicant: Dyson Technology Limited, Malmesbury, Wiltshire (GB)

(72) Inventors: Dominic Peter VAN DER WAALS, Swindon (GB); Benjamin James HOVELL, Tetbury (GB); Dalila EL ZEIN, Bristol (GB)

(21) Appl. No.: 19/123,405

(22) PCT Filed: Oct. 12, 2023
(86) PCT No.: PCT/IB2023/060279

§ 371 Date: Apr. 23, 2025

(30) Foreign Application Priority Data
Oct. 31, 2022 (GB) 2216075.8

(51) Int. Cl. B01D 46/44; B01D 46/00; B01D 46/46; B03C 3/011; B03C 3/36; F24F 8/108; F24F 8/30; F24F 110/20; F24F 110/64

(52) U.S. Cl. CPC B01D 46/442; B01D 46/0032; B01D 46/0047; B01D 46/46; B03C 3/011; B03C 3/368; F24F 8/108; F24F 8/30; B01D 2273/30; B03C 2201/24; F24F 2110/20; F24F 2110/64

(57) ABSTRACT

An air purification system for purification of ambient air is described herein. The air purification system includes an air ioniser system that electrically charges air molecules of the ambient air. The air ioniser system generates positively charged air molecules and negatively charged air molecules. A sensor system of the air purification system senses one or more physical properties of the ambient air. A controller controls the air ioniser system to change a ratio of positively charged air molecules to negatively charged air molecules generated based on the one or more sensed physical properties of the ambient air.

### FIELD OF THE INVENTION

The present invention relates to an air purification system.

### BACKGROUND

The problem of air pollution is becoming more and more serious and a variety of air pollutants are known or suspected to be harmful to human health. The negative effects that can be caused by air contaminants depend on the type and concentration of the contaminant, as well as the length of time of exposure to the contaminated air. For example, high levels of air pollution may immediately lead to health problems, such as exacerbation of cardiovascular and respiratory diseases, while long term exposure to polluted air may have permanent health effects, such as loss of lung capacity and reduced lung function, as well as the development of diseases, such as asthma, bronchitis, emphysema and possibly cancer.

Many people have recognized the benefit of minimizing their exposure to these pollutants and use air purifiers. An air purifier is an apparatus for air treatment which removes airborne particulates, including pollutants, from the air. Known examples of air purifiers use particulate filters that physically capture airborne particles by size exclusion, with a high-efficiency particulate air (HEPA) filter removing at least 99.97% of particulates with a size of 0.3 micrometres. Other known examples of air purifiers ionise the air to generate negative ions in order to thereby remove airborne particulates from the air. Some more advanced air purifiers combine multiple technologies, such as a particulate filter to physically capture airborne particulates and an air ioniser to generate negative ions, in order to further improve performance of the purifier. Ultimately the aim is to improve performance of air purifiers and ensure fast and efficient removal of airborne particulates from the air.

The present invention has been devised in light of the above considerations.

### SUMMARY OF THE INVENTION

According to a first aspect of the invention, there is provided an air purification system for purification of ambient air, the air purification system comprising: an air ioniser system configured to electrically charge air molecules of the ambient air, wherein the air ioniser system is configured to generate positively charged air molecules and negatively charged air molecules; a sensor system configured to sense one or more physical properties of the ambient air; and a controller configured to control the ioniser system to change a ratio of positively charged air molecules to negatively charged air molecules generated by the air ioniser system dependent on the one or more physical properties of the ambient air sensed by the sensor system.

As would be understood by a skilled person, this ratio would generally be understood to be:
0 if substantially only negative ions are generated by the air ioniser system
1 (which can also be expressed as 1:1) if substantially equal amounts of positively charged air molecules and negatively charged air molecules are generated by the air ioniser system
>>1 if substantially only positive ions are generated by the air ioniser system

As would also be understood by a skilled person, the exact ratio would not need to be measured to understand whether this ratio has changed, since this ratio can be understood as being changed if, for example, the air ioniser system is controlled to switch between any of the following:
generating substantially only negative ions
generating substantially equal amounts of positively charged air molecules and negatively charged air molecules
generating substantially only positive ions

By changing the ratio of positively and negatively charged air molecules generated dependent on one or more physical properties of the ambient air, purification by means of ionisation may be improved. For example, this may increase particle agglomeration such that airborne particles stick to each other and fall out of the air or are attracted to electrostatic surfaces.

In some examples, the one or more physical properties may include at least one physical property indicative of an overall electric charge of the ambient air; and the controller is configured to control the ioniser system to change the ratio of positively charged air molecules to negatively charged air molecules dependent on the overall electric charge of the ambient air.

Based on the overall charge of the ambient air, purification may be increased further. For example, generally neutral ambient air and generally charged ambient air may be ionised differently to increase purification.

In some examples, the physical property indicative of charge may be a direct measurement of electrical charge of the ambient air, while in other examples the physical property may not be a direct measurement of electrical charge but instead of a physical property indicative of overall charge. Suitable models for linking relevant physical properties to expected overall electrical charge may be known. For example, suitable models exist which link the number of particulates in the ambient air to expected overall electrical charge of the ambient air. Similarly, models exist for the distribution of particulate size, humidity and temperature.

In some examples, the controller may be configured to control the ioniser system to change the ratio of positively charged air molecules to negatively charged air molecules generated by the ioniser system so as to increase the overall electric charge of the air molecules (e.g. if the overall electric charge of the air molecules is positive, the ioniser system may be controlled to generate positive ions so as to increase the overall positive charge; e.g. if the overall electric charge of the air molecules is negative, the ioniser system may be controlled to generate negative ions so as to increase the overall negative charge).

By increasing the overall electrical charge of air molecules, particulate agglomeration may be increased as well as electrostatic attraction to surfaces. Particularly where the sensor system senses charged air molecules, it may be desirable to increase the electric charge of the air molecules for improved purification.

In some examples, the sensor system may include a charge sensor configured to sense the electrical charge of air molecules in the ambient air; and the electrical charge of air molecules detected by the charge sensor is indicative of the overall electric charge of the ambient air. For example, the charge sensor may be configured to measure a mean charge of the ambient air. The charge sensor may be provided as a Faraday cup electrometer to measure the total charge of an aerosol, wherein a single negative charge and a single positive charge would cancel. A device for measuring overall electrical charge may also be built as a product comparing measured current (particle charges) and concentration from an optical particle sensor.

In some examples, the one or more physical properties may include a parameter indicative of a concentration of particulates (particulates per unit volume) in the ambient air; and the sensor system may include a particulate sensor to detect the parameter indicative of a concentration of particulates in the ambient air. Here, the parameter may be measured by measuring an absolute number of particulates (from which the concentration can be inferred) and also, by directly measuring a concentration, e.g. number per cubic centimetre.

The parameter indicative of a concentration of particulates in the ambient air may be indicative of the overall electric charge of the ambient air. Suitable models linking the number of particulates to the overall electric charge of the ambient air are known to the skilled person.

In some examples, the controller may be configured to control the ioniser system to simultaneously generate positively charged air molecules and negatively charged air molecules if the parameter indicative of a concentration exceeds a predetermined threshold value.

Simultaneous generation of positive and negatively charged molecules may change the ratio of positively charged air molecules to negatively charged air molecules generated by the air ioniser system towards 1 (alternatively expressed as “1:1”). Preferably, the ratio is changed to approximately 1 (or “1:1”), such that substantially equal amounts of positively charged air molecules and negatively charged air molecules are generated.

Where a high concentration of particulates is detected in the ambient air, this may indicate that the separation between the particulates is smaller and that these particulates may be expected to be electrically neutral such that generating both positively charged and negatively charged air molecules may increase particulate agglomeration until airborne particulates cease being airborne. More particularly, without wishing to be bound by theory, it is believed that agglomeration results in particulates of increased size, which is believed to increase the Stokes settling velocity of particulates. In some examples, split airflows may be generated, e.g. into different directions or at different locations, to separately carry positively charged air molecules and negatively charged air molecules. Thus reactions with ambient air molecules may be increased and direct interaction between the generated positively and negatively charged air molecules, such as neutralisation, reduced.

Herein, it may be understood that the simultaneous generation of positively and negatively charged molecules may be achieved by generating the positively and negatively charged molecules at the same time (e.g. at two different locations), or by alternatively generating the positively and negatively charged molecules (e.g. at the same location) within a short predetermined period (which short predetermined period may be 60 seconds or less).

In some examples, the one or more physical properties may include at least one physical property indicative of the distribution of particulate sizes in the ambient air; and the sensor system includes one or more particulate sensors to detect the at least one physical property indicative of the distribution of particulate sizes in the ambient air.

The one or more particulate sensors may include particulate sensors configured to detect particulates having a given size. For example, the particulate sensors may include a PM1 sensor, a PM2.5 sensor and/or a PM10 sensor.

The one or more physical properties indicative of distribution of particle sizes in the ambient air may also be indicative of the overall electric charge of the ambient air. Suitable models linking the distribution of particulates to the overall electric charge of the ambient air are known to the skilled person.

In some examples, the controller may be configured to control the ioniser system to simultaneously generate positively charged air molecules and negatively charged air molecules if it is inferred from the one or more physical properties indicative of distribution of particle sizes in the ambient air that the amount (e.g. number or proportion) of particulates having a size falling below a threshold size exceeds a threshold (e.g. threshold value).

Preferably, simultaneous generation of positive and negatively charged molecules changes the ratio of positively charged air molecules to negatively charged air molecules generated by the air ioniser system towards 1 (alternatively expressed as “1:1”). More preferably, the ratio is changed to approximately 1 (or “1:1”), such that substantially equal amounts of positively charged air molecules and negatively charged air molecules are generated.

A large number of small particles may be expected to have generally neutral charge, such that simultaneously generating positively charged air molecules and negatively charged air molecules may be preferable.

In some examples, the at least one physical property may include an ambient humidity; and the sensor system includes a humidity sensor to detect the ambient humidity.

In some examples, the controller may be configured to control the ioniser system to decrease the ratio of positively charged air molecules to negatively charged air molecules if the detected ambient humidity exceeds a threshold humidity.

By decreasing the ratio of positively to negatively charged air molecules (i.e. increasing the amount of negatively charged ions generated relative to the number of positive ions generated), the overall electric charge may be increased more efficiently since high humidity may be indicative of a large number of neutral air molecules as a result of neutralisation/degradation of charged ions, and known examples of ioniser systems may more effectively generate negatively charged ions. More particularly, high humidity may assist in increasing the rate of neutralisation of positive or negative ions. To mitigate this high degradation rate, more ions would be required to be produced. This may be more efficiently achievable with a negative ion generator as these have been observed to generally produce more ions (O2 is easier to ionise than N2 for instance) and with high humidity the production of ionised water molecules may be efficient, thereby boosting rates even further.

In some examples, the ratio of positively to negatively charged air molecules may be decreased by generating only negatively charged air molecules.

In some examples, the at least one physical property may be ambient temperature; and the sensor system may include a temperature sensor to detect the ambient temperature.

In some examples, the air purification apparatus may be configured to change the ratio of positively charged air molecules to negatively charged air molecules generated by the air ioniser system by generating positively charged air molecules and negatively charged air molecules simultaneously.

In some examples, the air ioniser system may be configured to change the ratio of positively charged air molecules to negatively charged air molecules generated by the air ioniser system by generating either predominantly positively charged air molecules (preferably only positively charged air molecules) or predominantly negatively charged air molecules (preferably only negatively charged air molecules).

In some examples, the air purification system may further comprise a particulate filter and a fan assembly configured to generate an airflow through the particulate filter by drawing in ambient air.

By adding the particulate filter and the fan assembly, air purification may be further improved. In particular, generating charged air molecules may improve efficacy of the particulate filter as a result of agglomeration of air molecules and electrostatic attraction.

In some examples, the particulate filter, the fan assembly and the air ioniser system may be comprised in an air purification apparatus; and the sensor system includes at least one sensor internal to the air purification apparatus or the sensor system includes at least one sensor external to the air purification apparatus.

In some examples, the air purification system may include one or more additional air ioniser systems (e.g. which could be positioned at different locations in the same room which could, for example, help with the total agglomeration as mentioned above). The/each additional air ioniser system may be located within a same unit as the/each external sensor.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 is an illustration of an air purification system including an air purification apparatus.

FIG. 2 is another illustration of the air purification system of FIG. 1 showing also onboard components.

FIG. 3 is another illustration of the air purification system, including also multiple external sensors.

### DETAILED DESCRIPTION OF THE INVENTION

Aspects and embodiments of the present invention will now be discussed with reference to the accompanying figures. Further aspects and embodiments will be apparent to those skilled in the art.

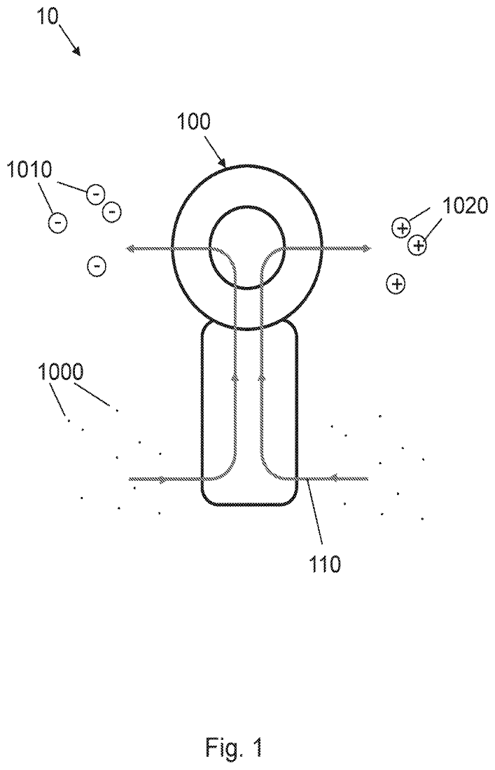

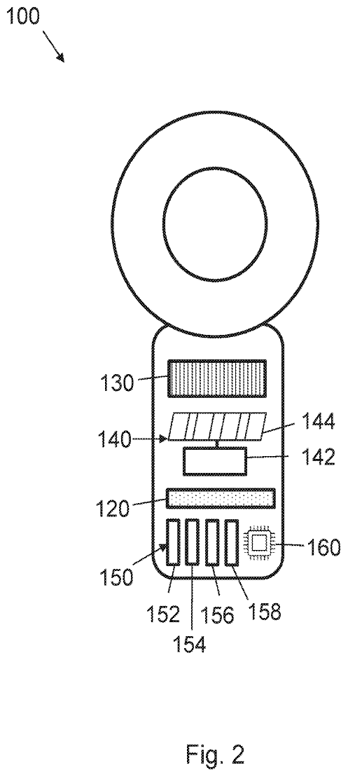

FIGS. 1 and 2 illustrate an exemplary air purification system 10. The air purification system 10 includes an air purification apparatus 100 configured to treat ambient air by removing airborne particulates. In this example, the apparatus 100 is configured to remove airborne particulates by means of ionisation and filtration. More generally, an apparatus 100 without filtration means is also envisaged, for example as part of a system including a separate filtration apparatus.

The apparatus 100 in use draws in ambient air and expels purified air by generating an airflow 110 through a particulate filter 120 and an air ioniser system 130. The particulate filter 120 is configured to retain particulates 1000, e.g. dust and other contaminants, carried in the airflow 110. The air ioniser system 130 is configured to generate electrically charged air molecules 1010, 1020 in the airflow 110 by generating negatively charged molecules 1010 and positively charged air molecules 1020. In use, the apparatus 100 returns air molecules to the ambient air which have been electrically charged by the air ioniser system 130, and the apparatus 100 retains particulates 1000 captured by the particulate filter 120. In this example, the air ioniser system 130 is located downstream of the particulate filter 120.

The apparatus 100 comprises a fan assembly 140 to generate the airflow 110. The fan assembly 140 causes ambient air to be drawn into the apparatus 100 and purified air to be returned to the ambient air. The fan assembly 140, which may also be referred to as a compressor, includes a motor 142 and a rotor 144 driven by the motor 142 to generate the airflow 110. In this example, the particulate filter 120 is located upstream of the fan assembly 140 and the air ioniser system 130 is located downstream of the fan assembly 140.

The apparatus 100 comprises a sensor system 150 configured to sense one or more physical property of the ambient air. The one or more physical properties describe or be indicative of an environmental condition or physical state of the ambient air, such as electrical charge, concentration of particulates (e.g. number of particulates per unit volume, such as per cubic centimetre), distribution of particulate sizes, and humidity. In the present example, the sensor system 150 is configured to sense a plurality of the physical properties of the ambient air.

The apparatus 100 comprises a controller 160 configured to control the air ioniser system 130 to change a ratio of positively charged air molecules 1020 to negatively charged air molecules 1010 generated by the air ioniser system 130 dependent on the plurality of physical properties of the ambient air sensed by the sensor system 150. By changing the ratio of positively and negatively charged air molecules 1010, 1020 generated dependent on the one or more physical properties of the ambient air, purification by means of ionisation may be improved. For example, this may increase particle agglomeration such that airborne particles stick to each other and fall out of the air or are attracted to electrostatic surfaces. Also, this may improve purification by means of filtration, since upon re-ingestion of air by the apparatus 100 further particulates may be captured by the particulate filter 120 as a result of agglomeration of particulates. Hence, the air purification system 10 provides for changeable polarity ionisation based on sensed data indicative of at least one physical property of the ambient air (or ‘environmental parameter’ or ‘environmental condition’) to improve purification.

In this example, the sensor system 150 comprises a charge sensor 152, a particulate sensor 154, a humidity sensor 156, and a temperature sensor 158.

The charge sensor 152 is configured to sense the electrical charge of the air molecules in the ambient air. The electrical charge of the air molecules detected by the charge sensor 152 is indicative of the overall electric charge of the ambient air. That is to say, the controller 160 determines whether the ambient air is generally positively charged, negatively charged or neutral based on output from the charge sensor 152.

Based on the charge sensor 152, the controller 160 is configured to control the air ioniser system 130 to change the ratio of positively charged air molecules 1020 to negatively charged air molecules 1010 generated by the air ioniser system 130 so as to increase the overall electric charge of the air molecules. In this example, the controller 160 controls the air ioniser system 130 to generate mainly or exclusively positively charged air molecules 1020 when it is determined that the ambient air is generally positively charged. Similarly, the controller 160 controls the air ioniser system 130 to generate mainly or exclusively negatively charged air molecules 1010 when it is determined that the ambient air is generally negatively charged. By increasing the overall charge of the ambient air, particulate agglomeration may be improved. Moreover, the delta between the electrical charge of the ambient air and, say, an electrostatic filter or surface is increased. That is to say, electrostatic attraction to surfaces may be improved since the difference in electrical charge may be increased and, correspondingly, electrostatic attraction increased. Thus, in some examples neutralisation of existing overall electrical charge of the ambient air is avoided, and instead the existing overall electrical charge is increased.

In this example, the physical property indicative of charge is a direct of measurement of electrical charge of the ambient air by means of the charge sensor 152. However, it is also possible that the physical property is not a direct measurement of electrical charge but instead of a physical property indicative of overall charge. Suitable models linking physical properties to of the ambient air to the expected electrical charge of the ambient air exist. As such, the other sensors of the sensor system 150 may also be used for estimating the overall electrical charge of the ambient air and the ioniser system 130 dependent on the estimated overall electrical charge.

The particulate sensor 154 is configured to detect a parameter indicative of a concentration of particulates in the ambient air, e.g. by directly measuring the concentration. Based on the particulate sensor 154, the controller 160 is configured to control the air ioniser system 130 to simultaneously generate positively charged air molecules 1020 and negatively charged air molecules 1010 if the parameter indicative of the concentration of particulates in the ambient air exceeds a predetermined threshold value. For example, the controller 160 may adjust the ratio of positively charged air molecules 1020 to negatively charged air molecules 1010 towards 1 (alternatively expressed as “1:1”). In this example, the controller 160 may adjust the ratio to approximately 1 (or “1:1”) such that substantially equal amounts of positively charged air molecules 1020 and negatively charged air molecules 1010 are generated by the air ioniser system 130 when the number of particulates detected in the ambient air exceeds the predetermined threshold value.

Where a high concentration of particulates is detected in the ambient air, these particulates may be expected to be electrically neutral such that generating both positively charged and negatively charged air molecules 1010, 1020 may increase particulate agglomeration, which may cause airborne particulates to fall out of the ambient air.

In this example, the controller 160 is configured to determine the distribution of particulate sizes in the ambient air based on the particulate sensor 154, in addition to the parameter indicative of the concentration of particulates in the ambient air.

Based on the particulate sensor 154, the controller 160 is configured to control the air ioniser system 130 to simultaneously generate positively charged air molecules 1020 and negatively charged air molecules 1010 if it is inferred from the one or more physical properties indicative of distribution of particle sizes in the ambient air that the amount of particulates having a size falling below a threshold size exceeds a threshold number. For example, the controller 160 may adjust the ratio of positively charged air molecules 1020 to negatively charged air molecules 1010 towards 1 (which may alternatively be expressed as “1:1”). In this example, the controller 160 may adjust the ratio to approximately 1 (or “1:1”) such that substantially equal amounts of positively charged air molecules 1020 and negatively charged air molecules 1010 are generated by the air ioniser system 130 when it is inferred from the one or more physical properties indicative of distribution of particle sizes in the ambient air that the amount of particulates having a size falling below a threshold size exceeds the threshold number.

In this example, the particulate sensor 154 is configured to detect particulates having a diameter of 1 micron or less, particulates having a diameter of 2.5 microns or less, and particulates having a diameter of 10 microns or less. Based on the output from the particulate sensor 154, the parameter indicative of the concentration of particulates in the ambient air is determined as well as the distribution of particulate sizes in the ambient air.

The humidity sensor 156 is configured to detect the ambient humidity.

Based on the humidity sensor 156, the controller 160 is configured to control the air ioniser system 130 to decrease the ratio of positively charged molecules 1020 to negatively charged molecules 1010 if the detected ambient humidity exceeds a threshold humidity. In this example, the ratio of positively charged molecules 1020 to negatively charged molecules 1010 is adjusted such that only negatively charged molecules 1020 are generated when the threshold humidity is exceeded. By decreasing the ratio of positively to negatively charged air molecules, the overall electric charge may be increased more efficiently, since high humidity may be indicative of a large number of electrically neutral air molecules, and generating negatively charged air molecules may be more efficient.

The temperature sensor 158 is configured to detect the ambient temperature. Based on the temperature sensor 158, the controller 160 is configured to control the ioniser system 130 to change the ratio of positively charged air molecules 1020 to negatively charged air molecules 1010 generated by the air ioniser system 130 dependent on the detected ambient temperature.

In summary, the air purification system 10 described above is configured to change the polarity of ionisation charging dependent on at least some of the following sensed data:
particle matter composition, such as size, material, charge, concentration; and/or
environmental conditions, such as humidity, pressure, temperature.

The air purification system 10 may provide for optimised reduction of particulates in the ambient air by means of:
negative ionization only,
positive ionization only,
a mixture of positive and negative ionisation at the same time, e.g. in different locations, and/or
a mixture of positive and negative ionisation, e.g. alternating between the two ionisations.

The air purification system 10 may therefore provide for:
increased particle agglomeration, so the particles stick to each other, making them larger and easier to filter;
increasing electrical charge on the particles meaning they are attracted electrostatically to a filter fibre; and/or
increasing electrical charge on the particles meaning they are attracted electrostatically to surfaces, such that they are no longer airborne.

The air purification apparatus 100 described above utilises the particulate filter 120 and the air ioniser system 130 to purify air. In other examples, the particulate filter 120 and the air ioniser system 130 may be provided in separate devices. In yet further examples, the air ioniser system 130 may be provided without the particulate filter 120.

The air ioniser system 130 described above is a single structure configured to generate positively charged air molecules 1020 and negatively charged air molecules 1010. In other examples, the air ioniser system 130 includes at least two separate structures arranged to generate positively charged air molecules 1020 and negatively charged air molecules 1010, respectively. In some examples, there is a single positive ioniser and a single negative ioniser in different locations. In some examples, there is single positive ioniser and a single negative ioniser in the same location (e.g. next to each other) with same electronics controller. In some examples, there is a plurality of negative and positive ionisers on the air purification apparatus 100. In some examples, the ioniser system is configured to change polarity based on the electronics controller.

The sensor system 150 includes multiple sensors 152, 154, 156 to sense multiple physical properties of the ambient air. In other examples, a different number of sensors may be provided. For example, a single sensor or a different plurality of sensors may be included in the apparatus 100.

The sensor system 150 described is included entirely in the air purification apparatus 100. In other examples, some of the sensors 152, 154, 156 may be external to the apparatus 100. That is to say, the sensors may be in a variety of locations, e.g. at the airflow inlet of the apparatus 100, at the airflow outlet of the apparatus 100, at remote sensing station, on a wearable smart device.

As described above, the particulate sensor 154 is used to determine the parameter indicative of the concentration of particulates in the ambient air as well as the distribution of particulate sizes in the ambient air. In other examples, the particulate sensor 154 may be used to determine only the overall number of particulates, or only the distribution of particulate sizes in the ambient air.

In the air purification apparatus 100 described above, the air ioniser system 130 is located downstream from the particulate filter 120. In other examples, the air ioniser system 130 is located upstream from the particulate filter 120. In either configuration, positively charged and negatively charged air molecules are generated in the airflow 110 before the airflow 110 is blown into the ambient air. Thus the ioniser system 130 is arranged to affect an environment in which the air purification system 10 is located, e.g. a room or other enclosed space.

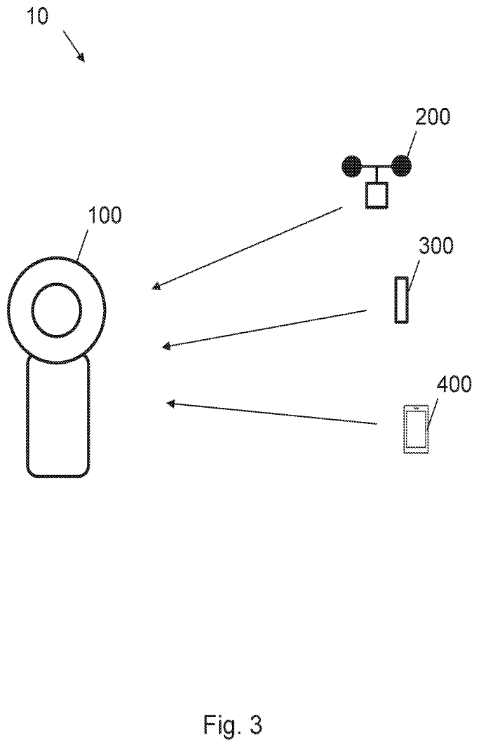

FIG. 3 illustrates the air purification system 10 including also a plurality of external sensors 200, 300, 400. In this example, the plurality of external sensors includes a first external sensor 200 configured to measure ambient humidity and temperature. The plurality of external sensors further includes a second external sensor 300 to detect airborne particulates. The plurality of external sensors further includes a smart device 400. The apparatus 100 is configured to suitably communicate with the plurality of external sensors 200, 300, 400, e.g. using Bluetooth or Wi-Fi. In examples, some or all of the external sensors may be present.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. An air purification system for purification of ambient air, the air purification system comprising:
an air ioniser system configured to electrically charge air molecules of the ambient air, wherein the air ioniser system is configured to generate positively charged air molecules and negatively charged air molecules;
a sensor system configured to sense one or more physical properties of the ambient air; and
a controller configured to control the air ioniser system to change a ratio of positively charged air molecules to negatively charged air molecules generated by the air ioniser system dependent on the one or more physical properties of the ambient air sensed by the sensor system.

2. The air purification system according to claim 1,
wherein the one or more physical properties include at least one physical property indicative of an overall electric charge of the ambient air; and
wherein the controller is configured to control the air ioniser system to change the ratio of positively charged air molecules to negatively charged air molecules dependent on the overall electric charge of the ambient air.

3. The air purification system according to claim 2,
wherein the controller is configured to control the air ioniser system to change the ratio of positively charged air molecules to negatively charged air molecules generated by the air ioniser system so as to increase the overall electric charge of the air molecules.

4. The air purification system according to claim 2,
wherein the sensor system includes a charge sensor configured to sense the electrical charge of air molecules in the ambient air; and
wherein the electrical charge of air molecules detected by the charge sensor is indicative of the overall electric charge of the ambient air.

5. The air purification system according to claim 1,
wherein the one or more physical properties includes a parameter indicative of a concentration of particulates in the ambient air; and
wherein the sensor system includes a particulate sensor to detect the parameter indicative of a concentration of particulates in the ambient air.

6. The air purification system according to claim 5,
wherein the controller is configured to control the air ioniser system to simultaneously generate positively charged air molecules and negatively charged air molecules if the parameter indicative of the concentration of particulates detected in the ambient air exceeds a predetermined threshold value.

7. The air purification system according claim 1,
wherein the one or more physical properties includes at least one physical property indicative of the distribution of particulate sizes in the ambient air; and
wherein the sensor system includes one or more particulate sensors to detect the at least one physical property indicative of the distribution of particulate sizes in the ambient air.

8. The air purification system according to claim 7,
wherein the controller is configured to control the air ioniser system to simultaneously generate positively charged air molecules and negatively charged air molecules if it is inferred from the one or more physical properties indicative of distribution of particle sizes in the ambient air that the amount of particulates having a size falling below a threshold size exceeds a threshold.

9. The air purification system according to claim 1,
wherein the at least one physical property includes an ambient humidity; and
wherein the sensor system includes a humidity sensor to detect the ambient humidity.

10. The air purification system according to claim 9,
wherein the controller is configured to control the air ioniser system to decrease the ratio of positively charged air molecules to negatively charged air molecules if the detected ambient humidity exceeds a threshold humidity.

11. The air purification system according to claim 1,
wherein the at least one physical property includes ambient temperature; and
wherein the sensor system includes a temperature sensor to detect the ambient temperature.

12. The air purification apparatus according to claim 1,
wherein the air purification apparatus is configured to change the ratio of positively charged air molecules to negatively charged air molecules generated by the air ioniser system by generating positively charged air molecules and negatively charged air molecules simultaneously.

13. The air purification apparatus according to claim 1,
wherein the air ioniser system is configured to change the ratio of positively charged air molecules to negatively charged air molecules generated by the air ioniser system by generating either only positively charged air molecules or only negatively charged air molecules.

14. The air purification system according to claim 1, further comprising:
a particulate filter; and
a fan assembly configured to generate an airflow through the particulate filter by drawing in the ambient air.

15. The air purification system according to claim 14,
wherein the particulate filter, the fan assembly and the air ioniser system are comprised in an air purification apparatus; and
wherein the sensor system includes at least one sensor internal to the air purification apparatus or the sensor system includes at least one sensor external to the air purification apparatus.
